(19) United States
(12) Patent Application Publication
(10) Pub. No.: US 2008/0109107 A1
(43) Pub. Date: May 8, 2008

(54) Method of performing a decoking cycle

(76) Inventors: Arthur N. Stefani, Houston, TX (US); Joshua Stephen Hogue, Missouri City, TX (US); Eberhard Lucke, Houston, TX (US); Rick O. Castillo, Houston, TX (US)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 11/592,572

(22) Filed: Nov. 3, 2006

(51) Int. Cl. G06F 17/00

(52) U.S. Cl. 700/207

(57) ABSTRACT

An integrated computer control process is used for a decoking cycle that takes into account all affected process variables including temperature, pressure, flow rates, and time related functions. Manual operator input is limited to setting the basis of the decoking cycle, which can include temperatures and pressure ranges, and monitoring key parameters, such as pressure tests.

### BACKGROUND OF THE INVENTION

1. Field of the Invention

This invention relates to a computer controlled delayed coking cycle, and more particularly to a method of integrating computer control in the decoking cycle to minimize manual operator control, all of which increases the reproducibility of the decoking cycle by minimizing operation upsets, and results in longer asset life.

In a typical delayed coker unit, a pair of coke drums are alternately filled and emptied manually by operational staff, with coker feed being pumped into one of the drums while the other drum is being emptied of coke and prepared for the next filling cycle. The capacity of a delayed coker is determined by several factors including the size of the coke drums, furnace capacity, pumping capacity, and the cycle time. In a coke controlled system, cycle time is directly proportional to capacity and the efficiency to which the operational staff performs the various steps needed to complete each cycle. Because drum size, furnace and pumping capacity are not easily changed, reducing cycle time through operational efficiency is sometimes the only variable that is available to increase coker capacity by allowing more drum fills in a given time period.

2. Background Art

Delayed coking technology is commonly used in petroleum refineries for converting vacuum tower bottoms and/or other heavy (i.e., high boiling point) residual petroleum materials to petroleum coke and other products. The greater part of each barrel of resid material processed in the coker will typically be recovered as fuel gas, coker naphtha, light coker gas oil, and heavy coker gas oil. Currently, the art views the decoking cycle as a series of separate manually operated steps. Each step is regarded as completely distinct from the preceding or following steps. The interaction of these steps—both positive and negative—is rarely considered, and the integration of decoking steps using a computer control system is basically nonexistent.

A conventional coking operation includes, in the process of emptying the filled drum, the steps of steaming out the filled drum to remove residual volatile material from the drum, quenching the steamed out coke bed with water, draining quench water from the drum, opening the top and bottom of the coke drum (unheading the drum), drilling a pilot hole in the coke bed from the top, drilling out the remaining coke with a radially directed jet drill, allowing the drilled out coke to exit the bottom of the drum, closing the top and bottom openings of the coke drum, purging and pressure testing the drum and preheating the empty coke drum by passing hot vapors from the other drum being filled with hot coker feed. The preheating step is necessary to bring the empty coke drum temperature up prior to switching the hot coker feed to the recently emptied drum, as otherwise the thermal stresses from feeding hot feed into a relatively cool drum would cause serious damage.

In the fill cycle, the hot feed material from the coker heater typically flows into the bottom of the live coking drum. Some of the heavy feed material vaporizes in the heater such that the material entering the bottom of the coking drum is a vapor/liquid mixture. The vapor portion of the mixture undergoes mild cracking in the coking heater and experiences further cracking as it passes upwardly through the coking drum. The hot liquid material undergoes intensive thermal cracking and polymerization in the coking drum such that the liquid material is converted to cracked vapor and petroleum coke. The resulting combined overhead vapor product produced in the coking drum is typically delivered to the fractionator wherein it is separated into gas, naphtha, light coker gas oil, and heavy coker gas oil, which are withdrawn from the fractionator as products, and the heavy recycle/residual material which flows to the bottom of the fractionator. The light and heavy coker gas oil products are typically taken from the fractionator as side-draw products. The heavy recycle material combines with the heavy feed material in the bottom of the fractionator and, as mentioned above, is pumped with the heavy feed material through the coker heater.

Two very serious problems that affect a delayed coker are thermal stresses in the coke drum and foam-overs to the fractionator, both of which can be affected by cycle time. Avoiding thermal stresses during the quenching of the coke drums requires slow initial cooling of the drum, which increases cycle time. Likewise, cycle time can be increased to achieve higher warm-up temperatures that minimize coke drum stresses due to hot feed introduction. Avoiding foam-overs requires a measured fill time of a live coke drum and controlled depressurization. The various steps in a coking system are presently performed manually by an operations staff. Such manual operation further adds to the cycle time due to human delays, mistakes, and inexperienced operators.

A need therefore exists to make delayed cokers more efficient in order to reduce cycle time and thus increase overall capacity of the unit operations. Moreover, a need now exists to develop an integrated approach to the decoking cycle. As explained in detail below, our invention solves this problem by eliminating manually-operated steps using a computer controlled switching cycle that links process parameters and increases reproducibility.

### SUMMARY OF THE INVENTION

According to our invention, integrated computer control is used for the decoking cycle, and takes into account all affected process variables including temperature, pressure, flow rates, and time related functions. Manual operator input is limited to setting the basis of the decoking cycle, which can include temperatures and pressure ranges, and monitoring key parameters, such as pressure tests. The benefits realized by our automated coking process include:

1. Faster warm-up, decreasing cycle time or allowing more time for other critical steps in the decoking cycle;

2. Higher potential warm-up temperatures will decrease coke drum stresses and potential cracking during introduction of hot feed thereby increasing coke drum life;

3. Coke drum pressure control will minimize/eliminate pressure swings in coke drums minimizing foam overs and reducing antifoam requirements;

4. Use of coke drum condensate as quench eliminates utility costs associated with re-vaporization of the coke drum condensate;

5. Longer drum life and less chance of blow outs with a computer controlled quench rate;

6. Reduced probability of coke bed cave-in's due to anti-slumping control steam;

7. Computer control gives reproducibility from cycle to cycle; and

8. Each control point references all affected variables.

More specifically, our invention involves a method of performing a decoking cycle in a delayed coker having at least two coke drums operating in a cyclical manner comprising, the following decoking steps:

a. manually initiating top and bottom head closing on the empty coke drum through a human operator interface;

b. executing a first computer control algorithm that performs the following steps
i. purging steam to the empty coke drum;
ii. closing empty coke drum vent valve and performing pressure test;
iii. injecting pressure control steam into a full coke drum; and
iv. warming-up the empty coke drum after pressure testing by monitoring a predetermined drum bottom temperature and warm-up duration time and continually monitoring a rate of overhead vapors diverted from the full coke drum into the empty drum, via condensate production, where the percentage opening of a back-pressure control valve is manipulated by the algorithm to control the overhead vapor flow rate by increasing pressure in the full coke drum;

c. executing a second computer control algorithm for controlling pressure in the coke drums during warm-up and drum switching, comprising,
i. maintaining drum pressure using a common overhead vapor valve and injecting anti slumping steam into the bottom of the full drum; and
ii. controlling the feed switching rate from the full coke drum to the empty coke drum using a pressure controller downstream of the back pressure control valve;

d. executing a third computer control algorithm for steam stripping the full coke drum comprising,
i. injecting steam into the full coke drum and continue overhead vapor flow to the fractionator;
ii. stopping overhead vapor flow to the fractionator and diverting overhead vapor flow to a blowdown tower while depressurizing the full coke drum at a given rate; and
iii. continue injecting steam into the full coke drum for coke bed striping to the blowdown tower;

e. executing a fourth computer control algorithm for quench water injection comprising,
i. monitoring full coke drum top pressure, rate of change of knee temperature and blowdown tower temperature and pressure to control ramp rate of the quench water to the full coke drum;
ii. diminishing anti-slumping steam injection as the quench water injection rate is ramped up; and
iii. after maximum water level is detected, stopping the quench water addition and draining the quench water from the full coke drum; and

f. manually initiating top and bottom head opening of the full coke drum and beginning manual hydraulic coke cutting operation.

### BRIEF DESCRIPTION OF THE DRAWINGS

FIG. 1 schematically illustrates one process configuration of our invention.

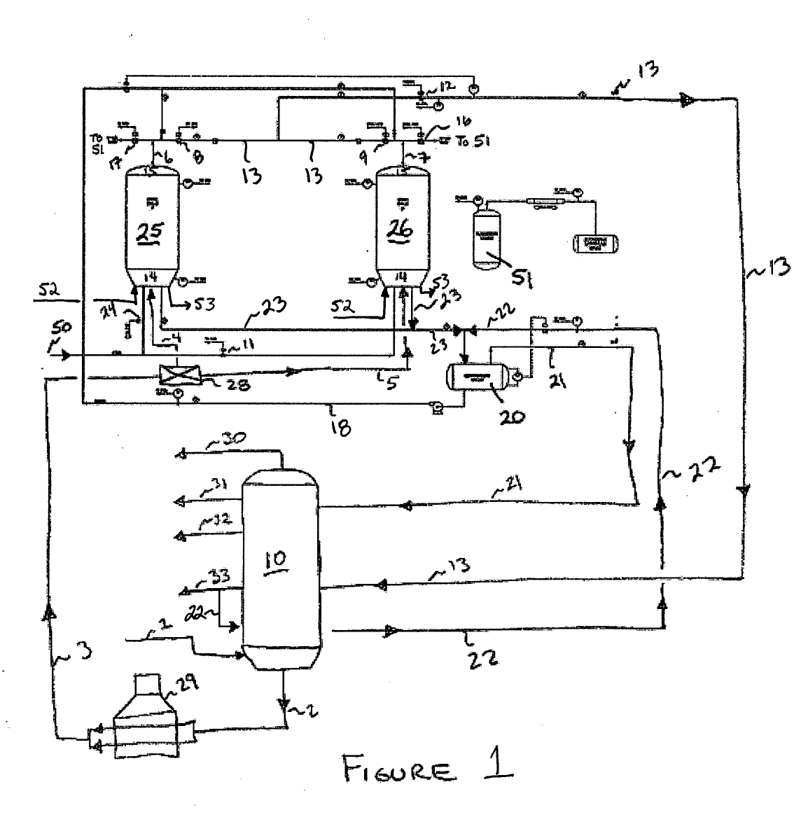

FIG. 2 schematically illustrates one embodiment of the warm-up computer control algorithm.

FIG. 3 schematically illustrates one embodiment of the switch sequence computer control algorithm.

FIG. 4 schematically illustrates one embodiment of the steam stripping computer control algorithm.

FIG. 5 schematically illustrates one embodiment of the quench water computer control algorithm.

### DESCRIPTION OF SPECIFIC EMBODIMENTS

The FIGURE provides one possible schematic illustration of the delayed coking unit operations that are operated according to the methods of our invention. The specific design of each piece of equipment or the exact arrangement of the equipment is not critical to our invention and alternative designs known to those skilled in the art are equally applicable to the methods described herein.

Crude vacuum resid and/or other heavy coker feed material flows through conduit 1 to the bottom portion of fractionator 10. In the bottom of fractionator 10, heavy fractionator bottoms liquid (recycle) combines with the coker feed. The resulting heavy liquid material is pumped via conduit 2 through coker heater 29. The hot material then flows through conduit 3 to switch valve 28. The coking system includes two vertical coking drums 25 and 26. Drums 25 and 26 are operated on alternating cycles such that, when one drum (i.e., the live drum) is operating in the fill cycle, the other drum is operating in the de-coking and preparation cycle. In prior art coking processes the de-coking and preparation cycle typically includes a sequence of manual operations including: a steaming stage; a cooling/quenching stage; a hydraulic de-coking stage; a pressure testing stage; and a warm-up stage. If drum 25 is operating in the fill cycle, valve 24 is closed and switch valve 28 diverts the hot feed material to the bottom of drum 25 via conduit 4. However, if drum 26 is operating in the fill cycle, valve 11 is closed and switch valve 28 diverts the hot feed material to the bottom of drum 26 via conduit 5. Assuming that drum 25 is operating in the fill cycle, drum 26 overhead valve 9 will be closed and drum 25 overhead valve 8 will be open (and valve 17 will be closed) such that the vapor produced in live drum 25 will flow to fractionator 10 via lines 6, and 13. Although only two coking drums 25 and 26 are shown in the FIGURE, those skilled in the art easily recognize that the methods of our invention can also be employed in a delayed coker having a plurality of coking drums.

Fractionator 10 will preferably include typical pump-around and condensing systems (not shown) for fractionating the vapor product. Typical products provided by the fractionator will include: an overhead cracked gas (e.g., fuel gas) product 30; an overhead gasoline/naphtha distillate product 31; a light coker gas oil side draw product 32; and a heavy coker gas oil side draw product 33. As indicated above, various names are used in the art to identify the light and heavy coker gas oil products.

When drum 26 reaches the warm-up stage of the second operating cycle, overhead valve 9 is opened such that a portion of the vapor product produced in live drum 25 flows into the top of drum 26 via line 7 and then into condensate drum 20 via line 23. Condensate produced in the warm-up process collects in condensate drum 20 and is removed via conduit 18 and is used as a quench stream. Quench make-up is supplied from fractionator 10 through line 22. The non-condensed warm-up material flows from condensate drum 20 to fractionator 10 via line 21.

As mentioned, the decoking cycle is traditionally carried out using a series of separate, manually-operated steps requiring human intervention. Our invention is an integrated, computer controlled, switching cycle that links all the affected parameters, thereby, increasing operational control and reproducibility of each step. All affected variables (temperature, pressure, flow, etc.) are inter-related within the computer control software. The automated sequence commences when the operator manually initiates the closure of both the top and bottom heads 14 and 15 and concludes with the full coke drum quench water drain. Once the computer algorithm starts, it first controls purge steam injection to the empty drum 26 by opening valve 11, closing valves 24 and 16. To begin a pressure test on empty drum 26, overhead valve 9 will be closed. Upon completion of a successful drum pressure test, the operator initiates computer controlled injection of pressure control steam in full drum 25 via valve 24 and activation of coke drum overhead pressure control valve 12 to maintain a preset coke drum operating pressure.

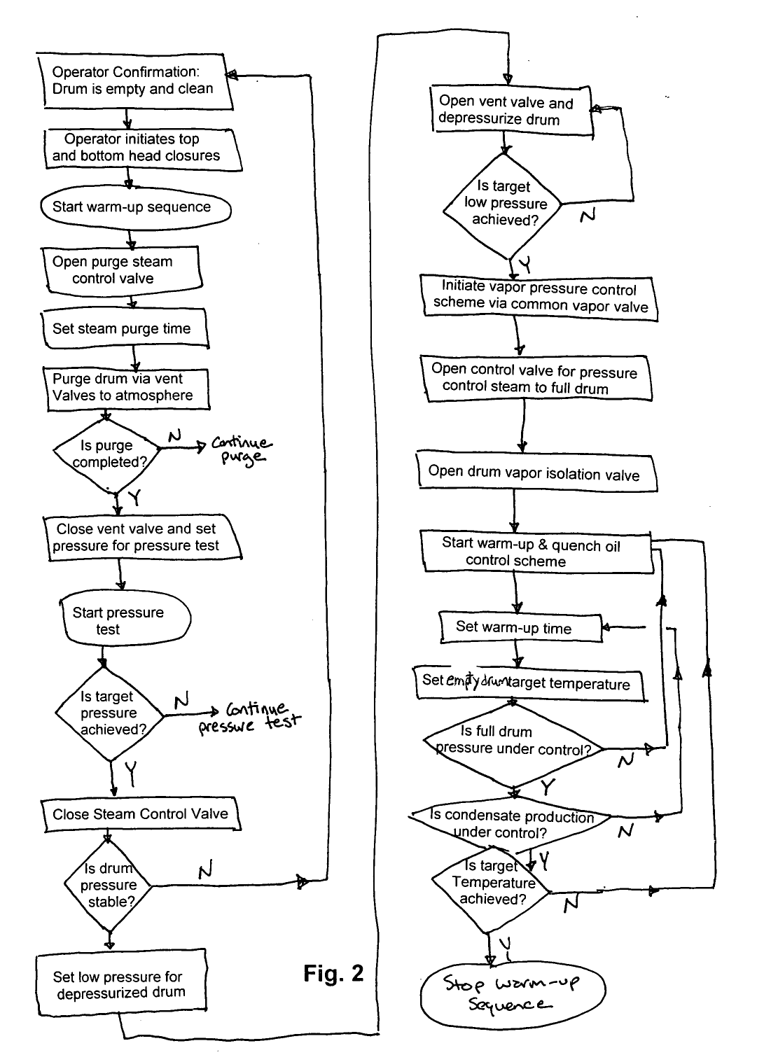

The computer then executes a fast warm-up algorithm for empty drum 26 based on a predetermined target coke drum bottom temperature and duration inputted into the computer by an operator. This is schematically illustrated in FIG. 2. The time required to pre-heat the empty coke drum is directly related to the rate at which the overhead vapors are diverted through the empty drum. In order to create the driving force necessary to increase this flow rate of vapors, this invention uses the back-pressure control system (via valve 12) to facilitate the higher flow rate, which also stabilizes the coke drum operating pressure, minimizing pressure swings due to changes in vapor flow to the fractionator 10. This will increase the pressure differential between the drums and the coker fractionator, overcoming the higher pressure differential from the blowdown condensate drum and balance line to the fractionator. Increasing the common overhead back pressure control valve 12 percentage closed will increase the coke drum operating pressure and the flowrate to the empty drum. Using the target temperature and time duration, the computer monitors other impacted variables, such as, condensate production, quench oil requirements, etc., to set valve 12 percentage closed.

In prior art coking processes, any hydrocarbon liquids that condense and then accumulate in the condensate drum have to be re-vaporized, which increases utility costs and takes the place of fresh feed in the coker heater. With our invention, the condensate drum 20 is converted into a quench oil surge drum. The quench oil portion of the heavy coker gas oil drawn from the coker fractionator 10 via line 22 is pumped into this drum rather than directly injecting it into the overhead line. As the amount of gas oil that is condensed in heating the empty coke drum 26 increases, the amount of gas oil drawn from the fractionator 10 will be decreased to maintain a level in the condensate drum 20. The computer will limit the rate of condensation of hydrocarbon liquid in the empty coke drum to the overall quench rate to inhibit overloading the condensate drum. All of the necessary quench oil will then be pumped via line 18 as needed from the condensate drum 20 to quench the overhead vapors of the active drum using known control equipment. A portion of the quench oil and quenched vapors from the full coke drum are then sent to the empty drum during the warm-up sequence. As the quench oil and full drum vapor combination contacts the cold drum a condensate is formed and is removed via line 23 and sent to condensate drum 20. The remaining portion quench oil and full drum vapor combination is removed to fractionator 10 via line 13. This recycle system eliminates the need to re-vaporize the warm-up condensate, as is required in current processes.

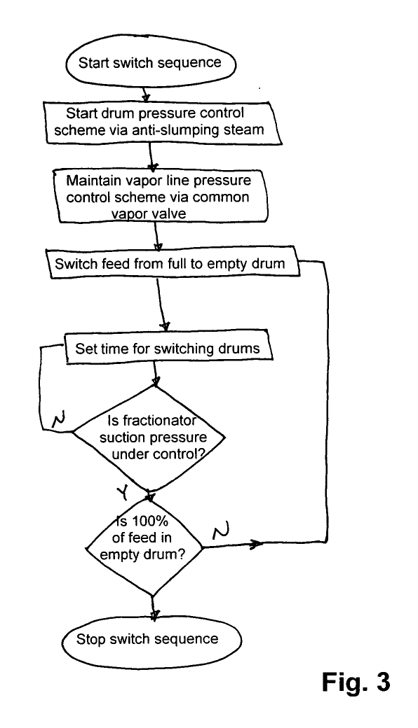

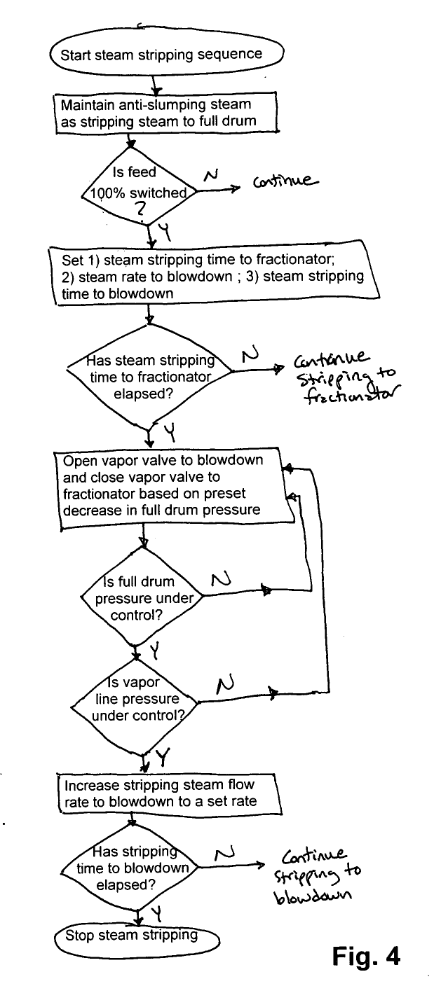

To fine tune the control of pressure in the coke drums during warm-up and switching, a steam injection algorithm is integrated into the controls system that maintains the drum pressure using the common overhead vapor valve 12 as gross control. This steam stripping algorithm is schematically illustrated in FIG. 4. Injecting steam into the bottom of the full drum 25 prior to starting the warm-up or switching step will protect against smaller pressure swings that cannot be controlled using the common overhead vapor valve alone. The computer will control the feed switching rate from full drum 25 to empty drum 26 using the pressure controller downstream of the back pressure control valve 12 to reflect the vapor load to the fractionator. This switching algorithm is schematically illustrated in FIG. 3. The empty coke drum bottom temperature will also be monitored as part of this step.

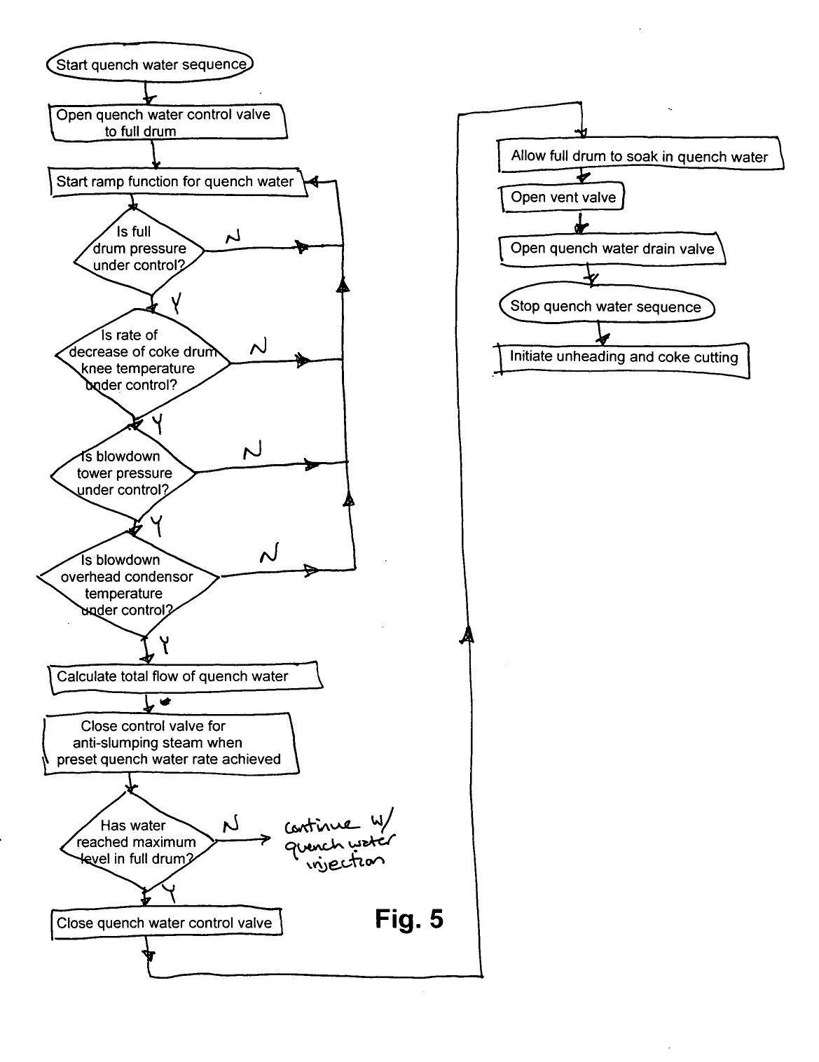

The computer controls increased steam injection via line 50 for coke bed stripping in full drum 25 to fractionator 10. Once stripping to the fractionator is complete, which is time and rate predetermined, the computer closes valve 8 to the fractionator and opens valve 17 to direct the overhead vapors to blowdown tower 51. The computer will then depressurize coke drum 25 to the blowdown tower 51 pressure on a predetermined ramp rate. Coke bed stripping in drum 25 using steam injection is controlled by the computer until the quench water injection begins, also time and rate predetermined. Quench water is introduced in to the bottom of a full drum via line 52. Once a preset level is reached within the drum, the water is drained via line 53 for disposal or other processing steps known to those skilled in the art. A known method of reducing coke drum damage due to the thermal cycles seen in the coking process is to ramp the injection rate of quench water. However, the use of quench water ramping alone, though better than other methods used, does not take into consideration that each coke bed forms differently with different porosity and the ability to distribute the quench water, especially if the product is shot coke. Our invention uses the traditional ramped injection rate method, but instead of being performed manually, the computer will use the inputs from each of the following to optimize the injection regime for fastest quench rate, maximum drum life, improved control of hot spots and efficient use of the blowdown system: a) the pressure at the top of the coke drum, b) the rate of change of temperature at the coke drum knee and c) the blowdown overhead condenser temperature and tower pressure. The use of computer control greatly reduces bed slumping as the quench water rate is increased. This is illustrated by the computer control algorithm shown in FIG. 5. Once the quench sequence is complete, then the operator initiates computer controlled coke drum drain, followed by full drum top head opening and full drum bottom head opening. The coke drum is now ready for hydraulic coke cutting.

As will be understood by those skilled in the art, the operating conditions employed in the delayed coker can vary substantially depending upon: the specific coker feed used; desired product specifications; desired product make; unit design; etc. Generally any desired conditions and parameters can be used when employing the methods of our invention.

We claim:

1. In a delayed coker having at least an empty coke drum and a full coke drum operating in a cyclical manner, performing decoking cycle steps comprising, in combination,
a. manually initiating top and bottom head closing of the empty coke drum through a human operator interface
b. executing a computer control algorithm that performs the following steps without human operator intervention:
warming-up the empty coke drum after pressure testing by monitoring a predetermined drum bottom temperature and warm-up duration time and continually monitoring a rate of overhead vapors diverted from the full coke drum into the empty coke drum via condensate production, where the computer control algorithm controls the overhead vapor flow rate by regulating percentage opening of a back-pressure control valve that increases or decreases the pressure in the full coke drum.

2. The decoking cycle of claim 1 where any one or more of the following steps is performed by the computer control algorithm:
i. purging steam to the empty coke drum;
ii. closing an empty coke drum vent valve and performing a pressure test; and
iii. injecting pressure control steam into the full coke drum.

3. The decoking cycle of claim 1 where a second computer control algorithm is executed for controlling pressure in the coke drums during warm-up and drum switching, comprising,
i. maintaining coke drum pressure using a common overhead vapor valve and injecting anti-slumping steam into the bottom of the full coke drum; and
ii. controlling feed switching rate from the full coke drum to the empty coke drum using a pressure controller downstream of the back pressure control valve.

4. The decoking cycle of claim 3 where a third computer control algorithm is executed for steam stripping the full coke drum comprising,
i. injecting steam into the full coke drum while continuing overhead vapor flow to a fractionator;
ii. stopping overhead vapor flow to the fractionator and diverting overhead vapor flow to a blowdown tower while depressurizing the full coke drum; and
iii. continue injecting steam into the full coke drum for coke bed stripping to the blowdown tower.

5. The decoking cycle of claim 4 where a fourth computer control algorithm is executed for quench water injection comprising,
i. monitoring full coke drum top pressure, rate of change of full coke drum knee temperature and blowdown overhead condenser temperature and tower pressure to control ramp rate of the quench water to the full coke drum; and
ii. diminishing anti-slumping steam injection as the quench water injection rate is ramped up.

6. The decoking cycle of claim 5 where the fourth computer control algorithm performs one or more of the following steps:
i. stopping quench water injection after a maximum water level is detected in the full coke drum.; and
ii. drains the injected quench water from the full coke drum.

7. A method of performing a decoking cycle in a delayed coker having at least an empty coke drum and a full coke drum operating in a cyclical manner comprising, in combination, the following steps,
a. manually initiating top and bottom head closing of the empty coke drum through a human operator interface;
b. executing a first computer control algorithm to perform the following steps in sequence without human operator intervention:
warming-up the empty coke drum after pressure testing by monitoring a predetermined drum bottom temperature and warm-up duration time and continually monitoring a rate of overhead vapors diverted from the full coke drum into the empty coke drum from condensate production, where the first algorithm controls the overhead vapor flow rate by controlling a back-pressure control valve that increases pressure in the full coke drum;
c. executing a second computer control algorithm for controlling pressure in the coke drums during warm-up and drum switching, comprising,
i. maintaining coke drum pressure using a common overhead vapor valve and injecting anti-slumping steam into the bottom of the full coke drum; and
ii. controlling feed switching rate from the full coke drum to the empty coke drum using a pressure controller downstream of the back pressure control valve; and
d. executing a third computer control algorithm for steam stripping the full coke drum comprising,
i. injecting steam into the full coke drum while continuing overhead vapor flow to a fractionator;
ii. stopping overhead vapor flow to the fractionator and diverting overhead vapor flow to a blowdown tower while depressurizing the full coke drum; and
iii. continue injecting steam into the full coke drum for coke bed stripping to the blowdown tower;
e. executing a fourth computer control algorithm for quench water injection comprising,
i. monitoring full coke drum top pressure, rate of change of full coke drum knee temperature and blowdown overhead condenser temperature and tower pressure to control ramp rate of the quench water to the full coke drum;
ii. diminishing anti-slumping steam injection as the quench water injection rate is ramped up; and
iii. stopping water addition after a maximum water level is detected in the full coke drum;
f. manually initiating top and bottom head opening of the second coke drum and beginning manual hydraulic coke cutting operation.

6. In a delayed coker having at least an empty coke drum and a full coke drum operating in a cyclical manner, performing decoking cycle steps comprising, in combination,
a. diverting a portion of a heavy coker gas oil stream from a fractionator to a condensate drum for use as a quench oil;
b. combining the quench oil with condensate resulting from condensation of a warm-up vapor stream passing through an empty coke drum into the condensate drum;
c. controlling the flow rate of the heavy coker gas oil stream fed to the condensate drum by monitoring the liquid level of the combination of condensate and quench oil in the condensate drum; and
d. supplying a portion of the combination of condensate and quench oil in the condensate drum to quench overhead vapors from the full coke drum.

7. In a delayed coker having at least an empty coke drum and a full coke drum operating in a cyclical manner, executing a decoking cycle computer control algorithm for controlling pressure in the coke drums during warm-up and drum switching comprising,
i. maintaining coke drum pressure using a common overhead vapor valve and injecting anti-slumping steam into the bottom of the full coke drum; and
ii. controlling feed switching rate from the full coke drum to the empty coke drum using a pressure controller downstream of the back pressure control valve; and

8. In a delayed coker having at least an empty coke drum and a full coke drum operating in a cyclical manner, executing a decoking cycle computer control algorithm for steam stripping the full coke drum comprising,
i. injecting steam into the full coke drum while continuing overhead vapor flow to a fractionator;
ii. stopping overhead vapor flow to the fractionator and diverting overhead vapor flow to a blowdown tower while depressurizing the full coke drum; and
iii. continue injecting steam into the full coke drum for coke bed stripping to the blowdown tower.

9. In a delayed coker having at least an empty coke drum and a full coke drum operating in a cyclical manner, executing a decoking cycle computer control algorithm for quench water injection comprising,
i. monitoring full coke drum top pressure, rate of change of full coke drum knee temperature and blowdown overhead condenser temperature and tower pressure to control a ramp rate of the quench water injected into the full coke drum; and
ii. diminishing anti-slumping steam injection as the quench water injection rate is ramped up.

10. The decoking cycle of claim 9 where the fourth computer control algorithm performs one or more of the following steps:
i. stopping quench water injection after a maximum water level is detected in the full coke drum.; and
ii. drains the injected quench water from the full coke drum.
